(19) United States
(12) Patent Application Publication
(10) Pub. No.: US 2023/0140858 A1
(43) Pub. Date: May 11, 2023

(54) UNIVERSAL STIMULATION CONNECTION TEST APPARATUS FOR ANIMAL ELECTRONIC COLLARS

(71) Applicant: E-Collar Technologies, Inc., Garrett, IN (US)

(72) Inventor: Greg Van Curen, Fremont, IN (US)

(73) Assignee: E-Collar Technologies, Inc., Garrett, IN (US)

(21) Appl. No.: 17/453,675

(22) Filed: Nov. 5, 2021

(51) Int. Cl. A01K 27/00; A01K 15/02

(52) U.S. Cl. CPC A01K 27/009; A01K 15/029; A01K 15/021

(57) ABSTRACT

An animal behavior modification system includes: an animal behavior modification assembly configured for modifying a behavior of an animal, the animal behavior modification assembly including: a collar device configured for being worn by the animal; a stimulation apparatus attached to the collar device, the stimulation apparatus including a plurality of electrodes configured for providing an electrical stimulation to the animal; and a stimulation connection test apparatus attached to the collar device and electrically coupled with the stimulation apparatus and configured for determining whether the plurality of electrodes are adequately electrically coupled with the animal, the stimulation connection test apparatus being spaced apart from the stimulation apparatus.

### BACKGROUND OF THE INVENTION

### 1. Field of the Invention

The present invention relates to animal behavior modification systems, and, more particularly, to animal behavior modification systems which apply an electrical shock to an animal.

### 2. Description of the Related Art

Electronic collars (which can be referred to as e-collars or e-collar assemblies) have been used to modify the behavior of animals, such as dogs (though dogs are referenced primarily herein, it can be appreciated that such collars can be used to modify the behavior of other animals as well). Such e-collars include a collar, which is worn by the dog, together with a stimulation unit attached to the collar. The stimulation unit can include a housing and a pair of electrodes, the housing being formed as a box housing electrical components therein, the electrodes extending externally relative to the box, the stimulation unit being able to selectively apply an electric current between the electrodes in order to render an electric shock to the dog's skin so as to modify the dog's behavior, without harming the dog. For example (and not by way of limitation, the e-collar can be used, for example, in conjunction with a containment system so to contain the dog within certain boundaries of a containment area, rendering an electronic shock to the dog when the dog encroaches upon the boundary of the containment area. Alternatively, the e-collar can be used with a hand-held transmitter which a dog owner or trainer, for example, uses to send a signal to the e-collar so as to cause the e-collar to emit an electrical shock to the dog.

However, such e-collars are useful so long as the e-collar actually emits the electrical charge to the dog's skin. This may not occur for various reasons. For example, a strap of the collar may be too loose, such that the electrodes do not make good contact with the skin of the dog. Further, the stimulation unit may be improperly located on the collar, the dog may have excessively dry skin, or contact points of the electrodes may otherwise not be oriented correctly and thus may not be making good electrical contact with the dog's skin. Known is a device that includes electrical components within the housing of the stimulation unit (this stimulation unit including the pair of electrodes, as indicated) that enables the dog owner or trainer (the user) to test whether the e-collar is properly installed on the dog such that the stimulation unit is making adequate electrical contact with the dog's skin by way of the electrodes so as to render an adequate electrical shock to the dog.

However, problems exist with such designs. For example, some users may not wish to have the additional feature of being able to perform the test, and thus may not wish to incur the additional expense for the additional feature. Others, however, may wish to have the feature of being able to perform the test but may need to perform such tests on various dogs each wearing an e-collar with a stimulation unit. Others may wish to have the feature of being able to perform the test but for various reasons may not wish this feature to be a part of the stimulation unit of the e-collar. Others may wish to have the feature of being able to perform the test and may wish to do so with their existing e-collar.

What is needed in the art is a device for testing the electrical connectivity of the stimulation unit of an e-collar assembly without this device being housed within the stimulation unit.

### SUMMARY OF THE INVENTION

The present invention provides a stimulation connection test apparatus of an e-collar assembly, the test apparatus being physically separate from the stimulation unit.

The invention in one form is directed to an apparatus of an animal behavior modification assembly for modifying a behavior of an animal, the animal behavior modification assembly including a collar device and a stimulation apparatus attached to the collar device, the apparatus including: a stimulation connection test apparatus configured for: being attached to the collar device, which is configured for being worn by the animal; being electrically coupled with the stimulation apparatus, which is configured for including a plurality of electrodes and for providing an electrical stimulation to the animal; determining whether the plurality of electrodes are adequately electrically coupled with the animal; and being spaced apart from the stimulation apparatus.

The invention in another form is directed to an animal behavior modification system, including: an animal behavior modification assembly configured for modifying a behavior of an animal, the animal behavior modification assembly including: a collar device configured for being worn by the animal; a stimulation apparatus attached to the collar device, the stimulation apparatus including a plurality of electrodes configured for providing an electrical stimulation to the animal; and a stimulation connection test apparatus attached to the collar device and electrically coupled with the stimulation apparatus and configured for determining whether the plurality of electrodes are adequately electrically coupled with the animal, the stimulation connection test apparatus being spaced apart from the stimulation apparatus.

The invention in yet another form is directed to a method for modifying a behavior of an animal, the method including the steps of: providing an animal behavior modification assembly including a collar device, a stimulation apparatus, and a stimulation connection test apparatus, the collar device configured for being worn by the animal, the stimulation apparatus being attached to the collar device and including a plurality of electrodes configured for providing an electrical stimulation to the animal; and determining, using the stimulation connection test apparatus attached to the collar device and electrically coupled with the stimulation apparatus, whether the plurality of electrodes are adequately electrically coupled with the animal, the stimulation connection test apparatus being spaced apart from the stimulation apparatus.

An advantage of the present invention is that the stimulation connection test apparatus can be selectively attached to various collars of an e-collar assembly and used in conjunction with a stimulation unit.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of an exemplary embodiment of an animal behavior modification system, the system including a transmitter and an animal behavior modification assembly, in accordance with an exemplary embodiment of the present invention;

FIG. 2 is a schematic electrical circuit diagram of the animal behavior modification assembly of FIG. 1, with portions broken away;

FIG. 3 is a schematic view of the animal behavior modification assembly, with portions broken away; and

FIG. 4 is a flow diagram showing a method for modifying a behavior of an animal, in accordance with an exemplary embodiment of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

Referring now to the drawings, and more particularly to FIG. 1, there is shown an animal behavior modification system 100 which generally includes a transmitter 101 and an animal behavior modification assembly 102 (which can be referred to as an electronic collar 102, or an e-collar 102) configured for modifying a behavior of an animal, which includes a collar device 103, a stimulation apparatus 104 (which can be referred to as stimulation unit 104, or unit 104), and a stimulation connection test apparatus 105 (which can be referred to as stimulation connection test apparatus 105, test apparatus 105, test unit 105, tester 105, voltage detection unit 105, or detector 105). The animal can be any animal but is referred to herein as a dog, merely by way of example.

Transmitter 101 is configured for communicating wirelessly with stimulation apparatus 104 and/or test apparatus 105. More specifically, transmitter 101 is configured for transmitting data signals 106, 107 to stimulation apparatus 104 and/or test apparatus 105 (the broken lines of data signals 107 indicating that direct communication between transmitter and test apparatus 105 is optional). Further, transmitter 101 can optionally be configured for also receiving data signals 106, 107 from stimulation apparatus 104 and/or test apparatus 105 (and in this sense can be more fully described as a transmitter-receiver, a transceiver). Data signals 106, 107 can be sent and/or received by, for example and not by way of limitation, radio signals (RF), optical signals, and/or acoustic signals. Alternatively or in addition thereto, transmitter 101 can communicate with stimulation apparatus 104 and/or test apparatus 105 in any other suitable way. For example, such ways can include Bluetooth, WiFi signals, cellular signals, and/or in any way involving the Internet, cloud-based devices, servers, smartphones (i.e., transmitter 101 can be formed as a smartphone), or the like. Further, data to or from transmitter 101 can be stored on any cloud-based device, and calculations (such as any described herein by controllers 321, 336 and/or any controller of transmitter 101) can be performed by any cloud-based device. Further, any alerts—such as alerts communicating to a user that electrodes 109, 110 are, or are not, in good contact with the animal's skin—can be provided by transmitter formed as a smartphone, though other options are described below (all options of which can be provided in the alternative or in addition to each other).

Collar device 103 (which can be referred to as collar 103) is configured for being worn by the dog, such as around the dog's neck. Collar 103 can include a strap that wraps around the dog's neck and any suitable connection device for connecting opposing free ends of the strap. FIG. 1 shows the free ends of the strap being connected by way of a buckle assembly. Other connection devices can be used instead, such as Velcro®, snaps, or a modified buckle assembly that does not include through-holes in the strap. Collar 103 can be adjustable. As is known in the art, collar 103 should fit snugly on the dog's neck, so as to ensure that stimulation apparatus 104 is able to deliver an adequate (but not harmful) electrical shock to the dog in order to modify the dog's behavior. The material of collar 103 can be any suitable material, such as leather, or a polymer.

Stimulation apparatus 104 is attached to collar 103. Stimulation apparatus 104 includes a housing 108, which can hermetically seal components therein. Such components include electrical components. Stimulation apparatus 104 further includes a plurality of electrically conductive electrodes 109, 110 (such as a pair of electrodes 109, 110, which can also be referred to as electrical probes 109, 110, or probes 109, 110) extending from housing 108 and radially inwardly when collar 103 is worn by the dog. Electrodes 109, 110 are spaced apart from one another but are configured for delivering an electrical current one to another. When collar 103 is worn by the dog, collar 103 should be fitted on the dog so that electrodes 109, 110 make contact with the dog's skin, in order that an electrical current can pass from one electrode to another by way of the dog's skin; in this way, electrodes 109, 110 are configured for providing an electrical stimulation to the animal. On the other hand, when electrodes 109, 110 do not make good electrical contact with the dog's skin, the circuit between electrodes 109, 110 becomes open. Thus, when good contact is made between electrodes 109, 110 with the dog's skin, stimulation apparatus 104, by way of the electrical components thereof, is configured for transmitting a very small current (nonlethal, and nonharmful) between electrodes 109, 110 of a very short duration (an electrical pulse), with the result that the electrical current is safe for the animal, as is known in the art. Stimulation apparatus 104 can be mechanically attached to collar 103 in any suitable manner, as is known in the art.

Test apparatus 105 includes a housing 111, which can hermetically seal components therein. Further, test apparatus is attached to collar 103 by way of a mechanical connection 112 and is electrically coupled with stimulation apparatus 104. Mechanical connection 112 is shown schematically in FIG. 1 and can be formed in any suitable manner, which can include, for example and not by way of limitation, Velcro® straps, strap(s) with a snap(s) and/or a button(s), a buckle assembly, a rivet(s), a screw(s), a bolt(s), and/or a snap(s). Depending upon the mechanical connection 112 used, test apparatus 105 can selectively, readily disconnect from and connect to various collars 103. Further, test apparatus 105 can electrically couple and decouple, at least in some embodiments of the present invention, with stimulation unit 104. This flexibility in mechanical connections and electrical coupling renders test apparatus universal. Test apparatus 105 is physically spaced apart from stimulation apparatus, as shown in FIG. 1.

Further, test apparatus 105 is electrically coupled with stimulation apparatus 104 in any suitable manner. This can include, for example, a wired connection 113 of assembly 102, as indicated in FIG. 1. Wired connection 113 includes a plurality of electrically conductive wires 114, 115 extending between test apparatus 105 and stimulation apparatus 104. Wires 114, 115 are configured for carrying an electrical current between electrical components of test apparatus 105 and electrodes 109, 110 of stimulation apparatus 104. For instance, wire 114 can be electrically coupled with electrode 109, and wire 115 can be electrically coupled with electrode 110. As indicated in FIG. 1, wires 114, 115 extend between side walls of housing 108 and housing 111. Further, as indicated in FIG. 1, wires 114, 115 can be hardwired to simulation apparatus 104 and test apparatus 105, such that wired connection 113 is essentially permanent. Further, according to an alternative embodiment of the present invention, wires 114, 115 can each include plugs on each of their opposing ends, and housings 108, 111 can each include sockets for mating with these plugs, such that wires 114, 115 can be readily connected to or disconnected from stimulation apparatus 104 and test apparatus 105. Further, according to an alternative embodiment of the present invention, wires 114, 115 can be connected to another portion of housings 108, 111 than what is shown in FIG. 1. For instance, wires 114, 115 could extend through a top wall (adjacent to the strap of collar 103) of housing 111, through the strap of collar 103 radially inwardly (similar to electrodes 109, 110), and then onward to stimulation apparatus 104. Further, rather than wires 114, 115 extending through the strap, a pair of electrodes could extend from the top wall of housing 111 and through the strap of collar 103, with wires 114, 115 extending between these electrodes of test apparatus 105 and electrodes 109, 110. Further, according to an alternative embodiment of the present invention, wires 114, 115 could be connected directly to electrodes 109, 110, respectively, without extending into housing 108 of stimulation apparatus 104. This connection could be essentially permanent (i.e., by soldering), or temporary, such that wires 114, 115 include clips on at least one of their ends so that these clips can connect to electrodes 109, 110, respectively. Further, according to an alternative embodiment of the present invention, alternatively or in addition to wired connection 113, stimulation apparatus 104 and test apparatus 105 can communicate wirelessly with each other. Such communication can include, for instance, data signals 116, such as RF signals, communicating electrical information or any other information between stimulation apparatus 104 and test apparatus 105. Alternatively or in addition thereto, stimulation apparatus 104 and test apparatus 105 can communicate with each other in any other suitable way. For example, such ways can include optical signals, acoustic signals, Bluetooth, WiFi signals, cellular signals, and/or in any way involving the Internet, cloud-based devices, servers, smartphones, or the like. For instance, data from stimulation device 104 and/or test apparatus 105 can be stored on any cloud-based device, and calculations (such as any described herein by controllers 321, 336) can be performed by any cloud-based devices.

Test apparatus 105 functions, at least in part, as a voltage detection device (i.e., a voltmeter, a potentiometer). In this way, when test apparatus 105 is electrically connected with stimulation apparatus 104 by way of wires 114, 115 (for example) and electrodes 109, 110, test apparatus 105 can detect the amount of voltage between electrodes 109, 110. Test apparatus 105, by way of wires 114, 115, is in parallel with the flow of electrical current between electrodes 109, 110 when electrical current flows through the dog's skin between electrodes 109, 110, and in series between electrodes 109, 110 when electrodes 109, 110 do not make good electrical contact with the dog's skin. In this way, test apparatus 105 can detect and thus measure the voltage across electrodes 109, 110, whether the electrical current between electrodes 109, 110 extends through the skin of the dog (a good electrical connection with the dog) or nor. Further, test apparatus 105, upon measuring the voltage between electrodes 109, 110, is configured for determining whether electrodes 109, 110 are adequately electrically connected with the skin of the dog. An adequate electrical coupling occurs only when both electrodes 109, 110 are in contact with the dog's skin (when this skin is not too dry). Test apparatus 105 is configured for determining whether electrodes 109, 110 are adequately electrically connected by at least in part using a voltage level signal corresponding to a voltage level difference between electrodes 109, 110, this voltage level being detected by test apparatus 105 by way of wires 114, 115 in electrical connection with electrodes 109, 110. That is, test apparatus 105 is configured for determining that electrodes 109, 110 are not adequately electrically connected when the voltage level (amount) across electrodes 109, 110 is greater than a predetermined voltage level; conversely, test apparatus 105 is configured for determining that electrodes 109, 110 are adequately electrically connected when the voltage level 109, 110 is at or below the predetermined voltage level. As discussed more below, test apparatus 105 includes a controller 336 configured for determining whether electrodes 109, 110 are adequately electrically connected with the dog's skin, using the voltage sensed, for instance, by wires 114, 115.

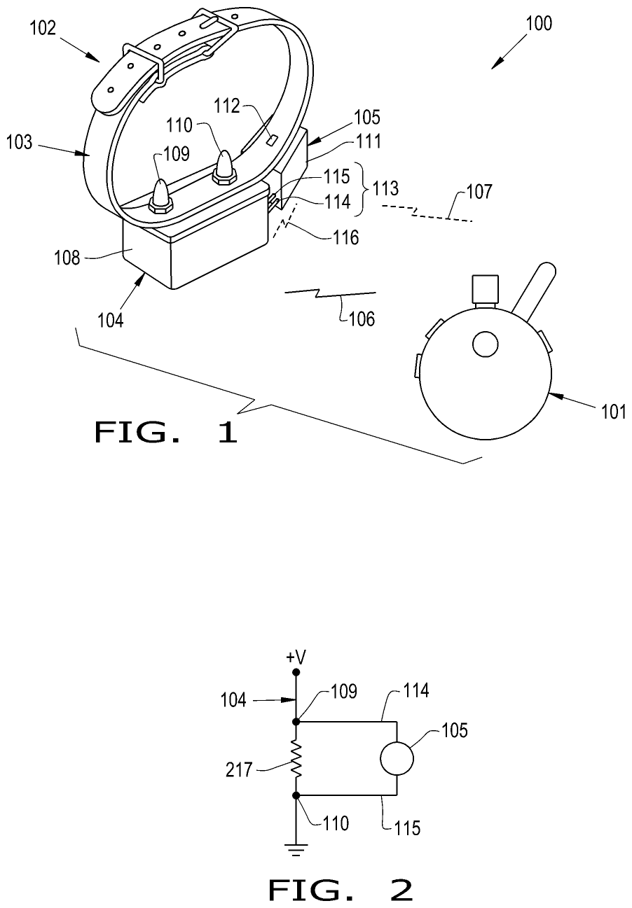

Referring now to FIG. 2, there is shown a circuit diagram, with portions broken away, of assembly 102. That is, stimulation apparatus 104 is electrically coupled with test apparatus 105 by way of wires 114, 115. More specifically, electrodes 109, 110 of stimulation apparatus 104 are electrically coupled with test apparatus 105 by way of wires 114, 115, respectively. Resistive element 217 is positioned between electrodes 109, 110 and thus correspond variably with either the dog's skin or the air. An adequate electrical coupling of electrodes 109, 110 occurs when resistive element 217 is the dog's skin. Under this scenario, tester apparatus 105 is in parallel with the current flow path extending from electrode 109 to electrode 110 (according to conventional view of current flow direction), and tester apparatus 105 can measure the voltage drop across resistive element 217, that is, between electrodes 109, 110. When an inadequate electrical coupling of electrodes 109, 110 occurs with the dog's skin, an open circuit occurs between electrodes 109, 110. Rather than showing a resistor in FIG. 2, an open switch could be used; however, resistive element 217 fits with this scenario as well, given that the air between electrodes 109, 110 is functioning as a resistor, albeit of a very high level of resistance, such that current does not flow between electrodes 109, 110, given the spacing between electrodes 109, 110.

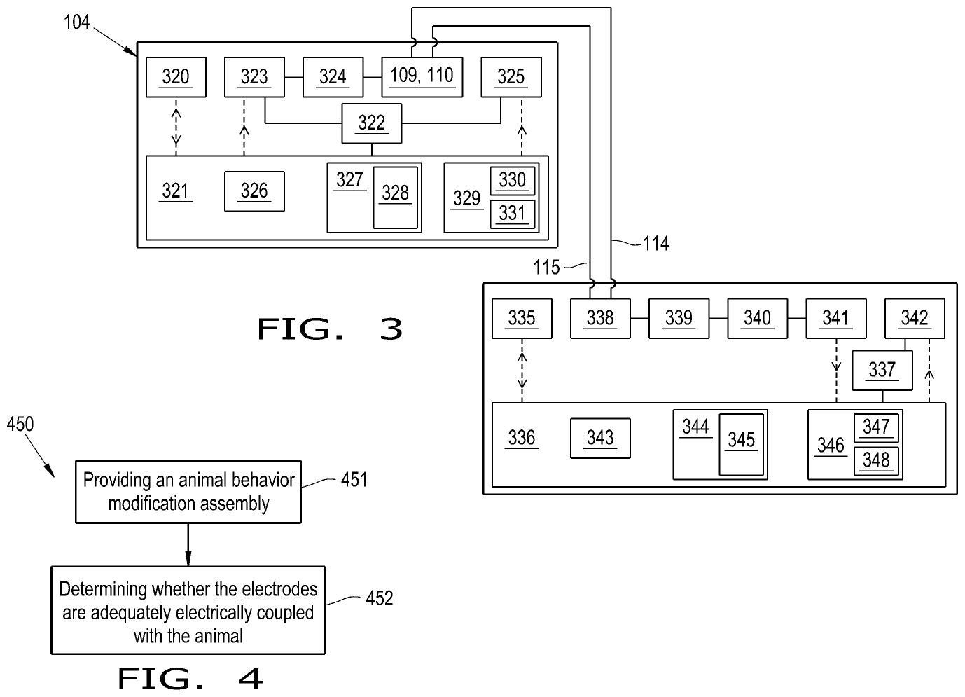

Referring now to FIG. 3, there is shown schematically assembly 102, including stimulation apparatus 104, wires 114, 115, and test apparatus 105, with collar 103 broken away. FIG. 3 shows but one embodiment of stimulation apparatus 104 and test apparatus 105. One skilled in the art will appreciate that stimulation apparatus 104 and test apparatus can include alternative components. For instance, it can be appreciated that converters of direct current (DC) to alternating current (AC), or vice versa, can be employed as a part of stimulation apparatus 104 and/or test apparatus 105. Further, a comparator (formed from an operational amplifier) can be employed, in addition to controller 336, by test apparatus 105, in order to determine whether the voltage detected across electrodes 109, 110 exceeds the predetermined threshold for the voltage level. Further, U.S. patent application Ser. No. 09/458,873, entitled “ELECTROSHOCK STIMULUS MONITORING METHOD AND APPARATUS”, filed Dec. 10, 1999, now U.S. Pat. No. 6,327,999, is incorporated herein by reference.

Stimulation apparatus 104 includes receiver 320, controller 321, power supply 322, signal unit 323, transformer 324, electrodes 109, 110, and alert mechanism 325. Receiver 320 is configured to receive any data communications from transmitter 101 and/or test apparatus 105. For instance, a user of system 100 may use hold transmitter 101 and send a signal by way of transmitter 101 to receiver 320 of stimulation apparatus 104 to generate a voltage and thus an electric current in order to run a voltage detection test so as to determine whether electrodes 109, 110 are making adequate electrical contact with the dog's skin. Though receiver 320 is referred to as a receiver, it is possible that receiver 320 can be configured as a transceiver, so as to be able to transmit data signals as well. For instance, receiver 320 can be configured as a transceiver and thereby be able to communicate data signals back to transmitter 101 (which itself can be configured as a transceiver) and/or to test apparatus 105. In accordance with one embodiment of the present invention, receiver 320 is configured to receive data signals from transmitter 101 to initiate a voltage detection test. Then, receiver 320 outputs a corresponding data signal to controller 321 and thereby functions as a relay between transmitter 101 and controller 321.

Controller 321 includes at least one processor 326, memory 327 which can store data 328, and instructions 329. Controller 321 is configured to receive the data signal from receiver 320 and, upon so receiving, can output a signal to cause signal unit 323 to be activated and thereby to close a switch so as to pass electrical current onward to transformer 324 from power supply 322, and thus on to electrodes 109, 110. A switch module 330 of controller 321 can form this switch signal. Further, according to one embodiment of the present invention, controller 321 can be configured to output an alert signal to alert mechanism 325 (if stimulation apparatus 104 has alert mechanism 325) so as to cause alert mechanism 325 to generate an alert signal to the user signifying either that electrodes 109, 110 are, or are not, making adequate electrical contact with the dog's skin (discussed below). An alert signal module 331 of controller 321 can form this alert signal.

Power supply 322 provides electrical power to any component of stimulation apparatus 104 that requires electrical power to function. For instance, power supply 322 can provide electrical power to controller 321, signal unit 323 (if necessary), transformer 324 (or, more specifically, a DC/AC converter preceding transformer 324), and/or alert mechanism 325, or any other element. Power supply 322 can be formed as a battery, for instance, and any DC/AC converters can be provided as necessary.

Signal unit 323 can be a device that is separate from power supply 322, as shown in FIG. 1. In one embodiment, signal unit 323 can be a switch (i.e., formed as a transistor) that is opened/closed by controller 321 and which transmits electrical current from power supply 322 when closed. A DC/AC converter can follow this switch in order to send electrical current, as AC current, to transformer 324. In another embodiment, signal generator can be any device which can generate a voltage and thus an electrical current, in the alternative or in addition to power supply 322.

Transformer 324 is a step-up transformer. As such, a primary winding of transformer 324 receives voltage from signal unit 323 (or power supply 322). In stepping-up the voltage level, a secondary winding of transformer 324 can be configured to output a voltage at a peak of 8,000 volts, for example. This voltage can be transmitted through circuitry to electrodes 109, 110 so as to generate an electrical current between electrodes 109, 110.

Alert mechanism 325 can be configured, for example, to emit a light or a noise corresponding to whether electrodes 109, 110 are making adequate electrical contact with the dog's skin. For instance, if light is employed, alert mechanism 325 can be a light emitting diode (LED), for example. A constant light can signify an adequate electrical connection between electrodes 109, 110, whereas a blinking light can signify an inadequate electrical connection. Alternatively, alert mechanism 325 can include two LEDs, one providing a green light signifying an adequate electrical connection, the other providing a red light signifying an inadequate electrical connection. If stimulation apparatus 104 includes alert mechanism 325, test apparatus 105 can send a signal to controller 321 corresponding to an adequate or inadequate electrical connection, so that controller 321 can output the corresponding signal to alert mechanism 325.

Test apparatus 105 includes receiver 335, controller 336, power supply 337, connection 338, voltage divider 339, pulse stretcher 340, analog-to-digital converter 341, and alert mechanism 342. Receiver can be similar to receiver 320. As such, receiver 335 is configured to receive any data communications from transmitter 101 and/or stimulation apparatus 104. For instance, as an alternative embodiment to what is described above (transmitter 101 sending a command signal to receiver 320 to cause stimulation apparatus 104 to generate a voltage relative to electrodes 109, 110), a user of system 100 may send a signal by way of transmitter 101 to receiver 335 to cause stimulation apparatus 104 to generate a voltage and thus an electric current in order to run a voltage detection test so as to determine whether electrodes 109, 110 are making adequate electrical contact with the dog's skin. In so doing, receiver 335 receives the signal from transmitter 101, communicates a corresponding signal to controller 336, which in turn causes receiver 335 (which can be configured as a transmitter as well, and thus be a transceiver) to transmit a voltage generation signal to stimulation apparatus 104 (by way of receiver 320 and controller 321). In this way, the voltage detection test can be initiated.

Controller 336 includes at least one processor 343, memory 344 which can store data 345, and instructions 346. Controller 336 can be configured to receive the data signal from receiver 335 (corresponding to the signal from transmitter 101 to initiate the voltage detection test) and, upon so receiving, outputs a voltage signal to stimulation apparatus 104 to cause voltage to be transmitted to an upstream electrode 109, 110 and thus, possibly, an electrical current between electrodes 109, 110. A voltage module 347 can form this voltage signal.

Further, controller 336, as indicated above, is configured to receive a signal, such as from analog-to-digital converter 341 (below), corresponding to the voltage level between electrodes 109, 110. Upon receipt of this voltage level signal, controller compares this voltage level signal (namely, a peak voltage level signal) to the predetermined voltage level threshold; if the voltage level signal is at or below the threshold, then this means that a good electrical connection is being made with the dog's skin; conversely, a voltage level signal above this threshold means an inadequate (i.e., a poor or nonexistent electrical connection) is being made with the dog's skin. Thus, a high voltage level suggests an inadequate electrical connection. This can be because an open circuit is formed between electrodes 109, 110 (the space between electrodes 109, 110 including air); as a result, the voltage at the upstream electrode (i.e., electrode 109) can be the same voltage as coming from signal unit 323 (or power supply 322), and the voltage at the downstream electrode (i.e., electrode 110) can be 0 volts (with test apparatus 105 functioning essentially as a voltmeter). The voltage level at the upstream electrode of electrodes 109, 110 can be, according to one embodiment of the present invention, 8,000 volts. The predetermined voltage level can be, for example and not by way of limitation, 1,000 volts.

Further, according to one embodiment of the present invention, controller 336 can be configured to output an alert signal to alert mechanism 342 (if test apparatus 105 has alert mechanism 342) so as to cause alert mechanism 342 to generate an alert signal to the user signifying either that electrodes 109, 110 are, or are not, making adequate electrical contact with the dog's skin. An alert signal module 348 can form this alert signal.

Power supply 337 provides electrical power to any component of test apparatus 105 that requires electrical power to function. For instance, power supply 337 can provide electrical power to controller 336 and/or alert mechanism 342, or any other element. Power supply 337 can be formed as a battery, for instance, and any DC/AC converters can be provided as necessary.

Connection 338 provides a way for wires 114, 115 to mechanically and electrically couple with components of test apparatus 105. For instance, the electrical circuitry of test apparatus 105 can include a plurality of wires and/or bus bars interconnecting various electrical components within housing 111. Alternatively, as indicated above, wires 114, 115 can include plugs which matingly interconnect with sockets of test apparatus 105.

Voltage divider 339 can be configured as a circuit which serves to lower the peak voltage level from electrodes 109, 110 and wires 114, 115, which can facilitate evaluation (measurement and comparison) of this peak voltage level. As indicated above, the input voltage to electrodes 109, 110 can be relatively high, for example and not by way of limitation, such as 8,000 volts, and depending the connection between electrodes 109, 110 this voltage level (8,000 volts) can be transmitted by wires 114, 115 to connection 338 and onward to voltage divider 339. Voltage divider 339 can include a high value resistor to reduce this incoming voltage to test apparatus 105 (as indicated by U.S. Pat. No. 6,327,999).

Pulse stretcher 340 can be configured as a circuit which receives the reduced voltage from voltage divider 339 and serves to produce a modified signal which has a longer decay time, or slower exponential decay. That is, the voltage across electrodes 109, 110 can have a voltage waveform that spikes up to a peak value and then exponentially decays relatively quickly. That is, the waveform has a relatively short decay time, which can cause the time period in which the waveform is at or near its peak voltage level to be too short for the peak value to be readily measured (as indicated in U.S. Pat. No. 6,327,999).

Analog-to-digital converter 341 can be configured to convert an analog signal to a digital signal. For instance, controller 336 may require a digital signal in order to perform its comparison operations. Accordingly, converter 341 can convert an analog signal from pulse stretcher 340 to a digital signal, which is then input into controller 336.

Alert mechanism 342 can be substantially similar to alert mechanism 325, and thus the description of alert mechanism 325 serves as a description of alert mechanism 342, except that alert mechanism 342 is in relation to controller 336. That is, once controller 336 determines whether the voltage level between electrodes 109, 110 (as however modified as described herein) is at or below the predetermined threshold voltage level (an adequate electrical connection at electrodes 109, 110), or is greater than this predetermined threshold voltage level (an inadequate electrical connection at electrodes 109, 110), controller 336 can output a corresponding alert signal alert mechanism 342 so that alert mechanism 342 provides the corresponding signal to the user. Alternatively or in addition thereto, controller 336 can output an alert signal to transmitter 101, so that transmitter 101 outputs an alert to user at transmitter 101, the alert of transmitter 101 being a light signal, a sound signal, a tactile signal (i.e., a vibration), and/or a text signal to user. Controller 336 can output this alert signal to transmitter by way of receiver 335 (as a transceiver).

Further, in general, controllers 321, 336 may each correspond to any suitable processor-based device(s), such as a computing device or any combination of computing devices. Each controller 321, 336 may generally include one or more processor(s) 326, 343 and associated memory 327, 344 configured to perform a variety of computer-implemented functions (e.g., performing the methods, steps, algorithms, calculations and the like disclosed herein). Thus, each controller 321, 336 may include a respective processor 326, 343 therein, as well as associated memory 327, 344, data 328, 345, and instructions 329, 346, each forming at least part of the respective controller 321, 336. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the respective memory 327, 344 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD), and/or other suitable memory elements. Such memory 327, 344 may generally be configured to store information accessible to the processor(s) 326, 343, including data 328, 345 that can be retrieved, manipulated, created, and/or stored by the processor(s) 326, 343 and the instructions 329, 346 that can be executed by the processor(s) 326, 343. In some embodiments, data 328, 345 may be stored in one or more databases.

In use, user can use transmitter 101 to send a signal to, for example, stimulation apparatus 104 in order to generate a test voltage relative to electrodes 109, 110. Stimulation apparatus 104 can generate the test voltage by way of controller 321, and upon doing so test apparatus 105 detects the voltage level between electrodes 109, 110 by way of wires 114, 115. This voltage sensed by wires 114, 115 is communicated to controller 336 as a voltage level signal. Controller 336 compares this voltage level signal to the predetermined voltage level, assessing whether the voltage level signal is at or below the threshold, or above the threshold. If the former, then the electrical connection of electrodes 109, 110 with the dog's skin is adequate; if the latter, then this electrical connection is inadequate. Controller 336 can output an alert signal to alert mechanism 342 (and/or to controller 321 and thus to alert mechanism 325, and/or to an alert mechanism of transmitter 101) to signify to the user that the electrical connection is adequate or inadequate, by way of, for example, lights or tones.

Referring now to FIG. 4, there is shown a flow diagram of a method 450 for modifying a behavior of an animal. Method 451 incudes the steps of: providing 451 an animal behavior modification assembly 102 including a collar device 103, a stimulation apparatus 104, and a stimulation connection test apparatus 105, the collar device 103 configured for being worn by the animal, the stimulation apparatus 104 being attached to the collar device 103 and including a plurality of electrodes 109, 110 configured for providing an electrical stimulation to the animal; and determining 452, using the stimulation connection test apparatus 105 attached to the collar device 103 and electrically coupled with the stimulation apparatus 104, whether the plurality of electrodes 109, 110 are adequately electrically coupled with the animal, the stimulation connection test apparatus 105 being spaced apart from the stimulation apparatus 104. The animal behavior modification assembly 102 can include a wired connection 113, the stimulation connection test apparatus 105 being electrically coupled with the stimulation apparatus 104 by the wired connection 113. The providing step 451 can further include providing a transmitter 101 configured for communicating with at least one of the stimulation apparatus 104 and the stimulation connection test apparatus 105. The step of determining can include using a voltage level signal corresponding to a voltage level between the plurality of electrodes 109, 110. Further, the step of determining can include determining that the plurality of electrodes 109, 110 are not adequately electrically coupled when the voltage level is greater than a predetermined voltage level. Further, the stimulation connection test apparatus 105 can include a controller 336 which performs the step of determining.

It is to be understood that the steps of method 450 are performed by controller 321, 336 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by controller 321, 336 described herein, such as the method 450, is implemented in software code or instructions which are tangibly stored on a tangible computer readable medium. The controller 321, 336 loads the software code or instructions via a direct interface with the computer readable medium or via a wired and/or wireless network. Upon loading and executing such software code or instructions by controller 321, 336, controller 321, 336 may perform any of the functionality of controller 321, 336 described herein, including any steps of the method 450.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An apparatus of an animal behavior modification assembly for modifying a behavior of an animal, the animal behavior modification assembly including a collar device and a stimulation apparatus attached to the collar device, the apparatus comprising:
a stimulation connection test apparatus configured for:
being attached to the collar device, which is configured for being worn by the animal;
being electrically coupled with the stimulation apparatus, which is configured for including a plurality of electrodes and for providing an electrical stimulation to the animal;
determining whether the plurality of electrodes are adequately electrically coupled with the animal; and
being spaced apart from the stimulation apparatus.

2. The apparatus of claim 1, wherein the stimulation connection test apparatus is configured for being electrically coupled with the stimulation apparatus by a wired connection.

3. The apparatus of claim 1, wherein at least one of the stimulation apparatus and the stimulation connection test apparatus is configured for communicating with a transmitter.

4. The apparatus of claim 1, wherein the stimulation connection test apparatus is configured for determining whether the plurality of electrodes are adequately electrically coupled by at least in part using a voltage level signal corresponding to a voltage level between the plurality of electrodes.

5. The apparatus of claim 4, wherein the stimulation connection test apparatus is configured for determining that the plurality of electrodes are not adequately electrically coupled when the voltage level is greater than a predetermined voltage level.

6. The apparatus of claim 5, wherein the stimulation connection test apparatus includes a controller configured for determining whether the plurality of electrodes are adequately electrically coupled.

7. An animal behavior modification system, comprising:
an animal behavior modification assembly configured for modifying a behavior of an animal, the animal behavior modification assembly including:
a collar device configured for being worn by the animal; and
a stimulation apparatus attached to the collar device, the stimulation apparatus including a plurality of electrodes configured for providing an electrical stimulation to the animal; and
a stimulation connection test apparatus attached to the collar device and electrically coupled with the stimulation apparatus and configured for determining whether the plurality of electrodes are adequately electrically coupled with the animal, the stimulation connection test apparatus being spaced apart from the stimulation apparatus.

8. The animal behavior modification system of claim 7, wherein the animal behavior modification assembly includes a wired connection, the stimulation connection test apparatus being electrically coupled with the stimulation apparatus by the wired connection.

9. The animal behavior modification system of claim 7, further including a transmitter configured for communicating with at least one of the stimulation apparatus and the stimulation connection test apparatus.

10. The animal behavior modification system of claim 7, wherein the stimulation connection test apparatus is configured for determining whether the plurality of electrodes are adequately electrically coupled by at least in part using a voltage level signal corresponding to a voltage level between the plurality of electrodes.

11. The animal behavior modification system of claim 10, wherein the stimulation connection test apparatus is configured for determining that the plurality of electrodes are not adequately electrically coupled when the voltage level is greater than a predetermined voltage level.

12. The animal behavior modification system of claim 11, wherein the stimulation connection test apparatus includes a controller configured for determining whether the plurality of electrodes are adequately electrically coupled.

13. A method for modifying a behavior of an animal, the method comprising the steps of:
providing an animal behavior modification assembly including a collar device, a stimulation apparatus, and a stimulation connection test apparatus, the collar device configured for being worn by the animal, the stimulation apparatus being attached to the collar device and including a plurality of electrodes configured for providing an electrical stimulation to the animal; and
determining, using the stimulation connection test apparatus attached to the collar device and electrically coupled with the stimulation apparatus, whether the plurality of electrodes are adequately electrically coupled with the animal, the stimulation connection test apparatus being spaced apart from the stimulation apparatus.

14. The method of claim 13, wherein the animal behavior modification assembly includes a wired connection, the stimulation connection test apparatus being electrically coupled with the stimulation apparatus by the wired connection.

15. The method of claim 13, wherein the providing step further includes providing a transmitter configured for communicating with at least one of the stimulation apparatus and the stimulation connection test apparatus.

16. The method of claim 13, wherein the step of determining includes using a voltage level signal corresponding to a voltage level between the plurality of electrodes.

17. The method of claim 16, wherein the step of determining includes determining that the plurality of electrodes are not adequately electrically coupled when the voltage level is greater than a predetermined voltage level.

18. The method of claim 17, wherein the stimulation connection test apparatus includes a controller which performs the step of determining.
